(19) United States
(12) Patent Application Publication
(10) Pub. No.: US 2016/0215635 A1
(43) Pub. Date: Jul. 28, 2016

(54) STEAM TURBINE AND A METHOD FOR RETROFITTING A MULTI-STAGE PARTIAL ARC OF ADMISSION STEAM TURBINE

(71) Applicant: ALSTOM Technology Ltd, Baden (CH)

(72) Inventors: Adrian Clifford Lord, Warwickshire (GB); David Lloyd Bell, Northamptonshire (GB)

(21) Appl. No.: 15/000,386

(22) Filed: Jan. 19, 2016

(30) Foreign Application Priority Data
Jan. 23, 2015 (EP) 15152382.6

(51) Int. Cl. F01D 9/06; F01D 5/06; F01D 25/26

(52) U.S. Cl. CPC F01D 9/06; F01D 25/26; F01D 5/06; F05D 2220/31; F05D 2230/80; F05D 2240/12; F05D 2240/24

(57) ABSTRACT

A method of retrofiting a multi-stage partial arc or admission steam turbine and a steam turbine obtainable by the method. The method comprises forming at least one inlet belt in the inner housing downstream of at least one the first blade rows of the steam turbine and forming a duct, connecting the first inlet line and the or each inlet belt. The duct and the inlet belt are adapted to enable a steam to pass through the first inlet line and bypass the first blade row of the steam turbine and the connection of the duct to the first inlet line is such that all steam flowing through the first inlet line passes through the duct.

### CROSS-REFERENCE TO RELATED APPLICATIONS

This application claims priority to European Patent Application No. 15152382.6 filed Jan. 23, 2015, the contents of which are hereby incorporated in its entirety.

### TECHNICAL FIELD

The present disclosure relates generally to methods for retrofitting steam turbines and more specifically to the retrofit of partial arc admission steam turbines.

### BACKGROUND

Small and mid-sized turbines are widely used for electricity generation. The small inlet volume flow rate of these machines means they only require minimal inlet flow area. As a result these machines are typically configured with short blade heights and small gauging angles. This configuration may result in significant efficiency reduction. A well-known approach to address this problem is to admit steam through more than one arc in a so call partial arc admission configuration in which flow through each arc is controlled by separate control valves. Partial admission is widely used in the first (control) stage of such turbines and sometimes even for subsequent group of stages. In general, the efficiency of the first partial stage and downstream stages depends on many parameters include the total level of admission, the number and tangential location of admission arcs, and the geometry of mixing chamber s between first and downstream stages. Proper combination of the above mentioned parameters may lead to improvements in turbine performance.

In particular for steam turbines that are required to have a wide operating range and high efficiency, the combination of partial arc admission, which may be coupled with sliding pressure control, may not provide a complete solution. For new installations, a solution is to further include a bypass overload valve, described, for example, in U.S. Pat. No. 4,403,476A. This arrangement makes it possible to increase the swallowing capacity of the steam turbine by controllably bypassing a portion of steam around upstream blade rows of the steam turbine when the feed control valves are fully opened.

While an existing partial arc admission steam turbine may benefit from an overload arrangement, the retrofit of the arrangement is both complexity and costly.

### SUMMARY

Provided is a retrofit method for retrofiting a partial arc of admission steam turbine with an overload arrangement.

It attempts to address this problem by means of the subject matters of the independent claims. Advantageous embodiments are given in the dependent claims.

One general aspect includes a method for retrofitting a multi-stage partial arc of admission steam turbine. This involves first providing a steam turbine that has an inner housing supporting a plurality of blade rows, an outer housing surrounding the inner housing, a blade row, a first arc of admission connected to a first inlet as well as a plurality of second arc of admission, each connecting to a second inlet line. The first arc of admission and the plurality of second arc's of admission are located upstream of the plurality of blade rows so as to together form a main admission. The method also includes forming at least one inlet belt in the inner housing in downstream of at least one of the blade row as well as forming a duct that extends between the first inlet line and the inlet belt. By further isolating the first arc of admission from the first inlet line, the arrangement enables flow through the first inlet line to bypass the first blade row.

Further aspects may include one or more of the following features. Fully containing the duct between the inner housing and the outer housing. Reconfiguring the plurality of second arcs of admission so as to enable full arc of admission through the second arcs of admission. The plurality of second arc of admission consisting of three arcs of admission.

Another general aspect includes multi stage partial arc of admission steam turbine that includes a steam turbine that has an inner housing supporting a plurality of blades, a blade row, an outer housing surrounding the inner housing as well as a first arc of admission connected to first inlet line and a plurality of second arcs of admission that together from a main admission to the blade row. The steam turbine also includes forming at least one inlet belt in the inner housing downstream of the first blade row and a duct that connects the first inlet line and the or each inlet belt. The duct and the inlet belt are adapted to enable a steam to pass through the first inlet line and bypass at least the first blade row while the connection of the first inlet line and the or each inlet belts is such that all steam flowing through the first inlet line flows through the duct.

Other aspects and advantages of the present disclosure will become apparent from the following description, taken in connection with the accompanying drawings which by way of example illustrate exemplary embodiments of the present invention.

### BRIEF DESCRIPTION OF THE DRAWINGS

By way of example, an embodiment of the present disclosure is described more fully hereinafter with reference to the accompanying drawings, in which:

FIG. 1 is a sectional view of a prior art steam turbine to which exemplary embodiments may be applied;

FIG. 2 is a sectional view of the inner casing and blade rows of the steam turbine of FIG. 1 to which an exemplary embodiment has been applied, and

FIG. 3 is an end section view of one exemplary embodiment of the steam turbine of FIG. 1 showing arcs of admission.

### DETAILED DESCRIPTION

Exemplary embodiments of the present disclosure are now described with references to the drawings, wherein like reference numerals are used to refer to like elements throughout. In the following description, for purposes of explanation, numerous specific details are set forth to provide a thorough understanding of the disclosure. However, the present disclosure may be practiced without these specific details, and is not limited to the exemplary embodiment disclosed herein.

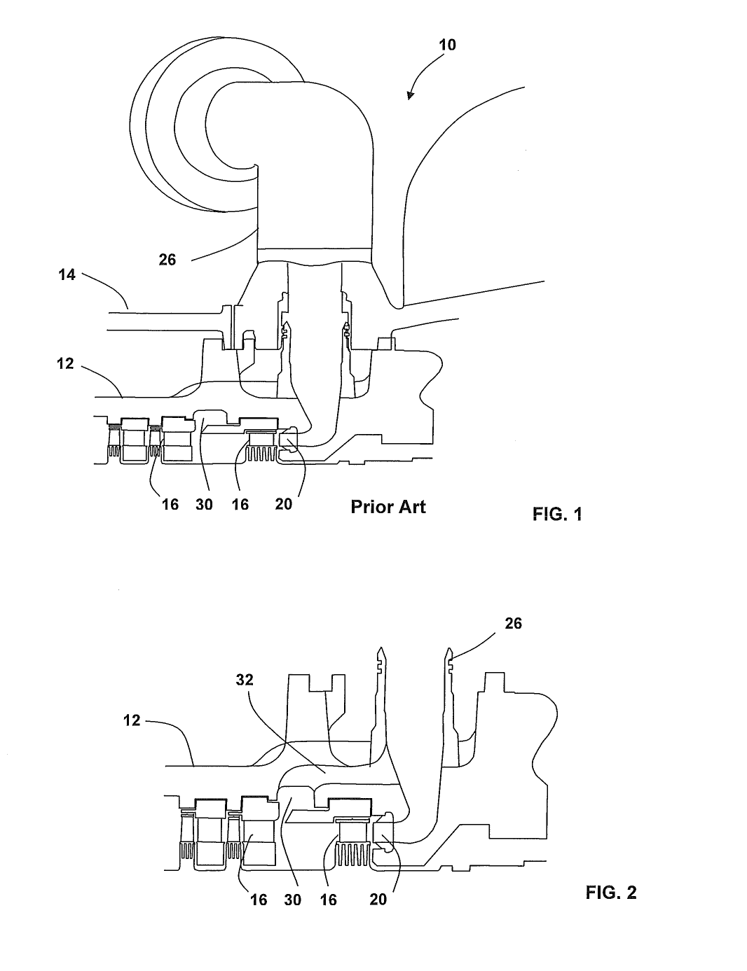

FIG. 1 shows a multi-stage partial arc of admission steam turbine 10 of the art. The steam turbine 10 has an inner housing 12 that supports a plurality of blade rows includes a first blade row 18 and an outer housing 14 that surrounds the inner housing. Steam enters the turbine via a plurality of feed lines 24, 26 each connected to arcs of admission 20 that feed the first blade row 18 and collectively form a main admission.

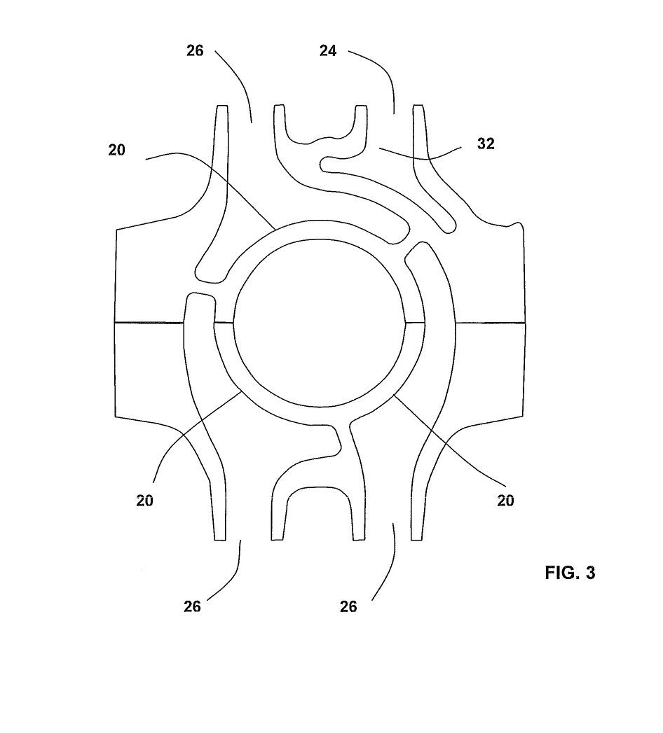

In an exemplary embodiment, the steam turbine of FIG. 1 is modified by forming at least one inlet belt 30 in the inner housing 12 at an intermediate stage of the steam turbine. In this context an inlet belt 30 is taken to mean a groove or duct at least partially circumscribing the steam turbine whose purpose is to enable the circumferential admission of steam to the steam turbine at any point of the steam turbine, including an intermediate stage. A duct 32 is then formed to connect one of the feed inlets lines 24 with the inlet belt 30 so as to forming a steam bypass around at least one of the first blade rows 18 located at an upstream end of the steam turbine. The bypass is further achieved by isolating the partial arc connected to the inlet line 24 from the inlet line 24. In this way the inlet line 24 that prior to the modification was connected to an arc of admission 20 is now solely connected to the duct 32 such that all steam flowing through the inlet line 24 passes through the duct 32. As is shown in FIG. 2 and FIG. 3, the duct 32 is not connected to other inlet lines 26, which remain connected to other arcs of admission 20.

In a not shown exemplary embodiment more than one duct 32 may be connected to more than one inlet belt 30.

In an exemplary embodiment, the arc of admission disconnected from the inlet line 24 is a blank arc of admission that is no connected to any feed inlet lines 26.

In an exemplary embodiment, following the connection of one of the inlet lines 24 to the duct 32, at least one of the remaining inlet lines 26 is connected to the arc of admission formally connected the first inlet line 24 thus enable fully arc of admission through the remaining inlet lines 26.

In an exemplary embodiment, an exemplary of which is shown in FIG. 3, the modified steam turbine has three arcs of admission 20, reduced from four arcs of admission 20 prior to the modification. In other not shown exemplary embodiments the modification is applied to a steam turbine 10 that has six arcs of admission 20 resulting in a steam turbine 10 with one inlet line 24 connected to a duct 32 and five arcs of admission.

In an exemplary embodiment, the duct 32 is contained within the inner housing 12 without modification of the outer house 14.

Although the disclosure has been herein shown and described in what is conceived to be the most practical exemplary embodiment the present disclosure can be embodied in other specific. The presently disclosed embodiments are therefore considered in all respects to be illustrative and not restricted. The scope of the disclosure is indicated by the appended claims rather that the foregoing description and all changes that come within the meaning and range and equivalences thereof are intended to be embraced therein.

1. A method for retrofitting a multi-stage partial arc of admission steam turbine, comprising:
providing a steam turbine comprising:
an inner housing supporting a plurality of blades rows;
an outer housing surrounding the inner housing;
a first blade row at an upstream end of the plurality of blade rows;
a first arc of admission;
a first inlet line connected to the first arc of admission; and
a plurality of second arcs of admission, which together with the first arc of admission form a main admission to the first blade row;
forming at least one inlet belt in the inner housing downstream of the first blade row;
forming a duct, connecting the first inlet line and the at least one inlet belt fully contained within the outer housing; and
isolating the first inlet line from the first arc of admission between the duct and the first arc of admission,
wherein the duct and the inlet belt is configured and arranged to enable a steam to pass through the first inlet line and bypass the first blade row of the steam turbine wherein the connection of the duct to the first inlet line is such that all steam flowing through the first inlet line passes through the duct.

2. The method of claim 1, wherein the duct is fully contained between the inner housing and the outer housing.

3. The method of claim 1, wherein the duct is formed wholly by the inner housing.

4. The method of claim 1, further including reconfiguration of the plurality of second arcs of admission so as to enable full arc of admission through the plurality of second arcs of admission.

5. The method of claim 4, wherein the plurality of second arcs of admission consists of three arcs of admission.

6. The method of claim 2, further including reconfiguration of the plurality of second arcs of admission so as to enable full arc of admission through the plurality of second arcs of admission.

7. The method of claim 6, wherein the plurality of second arcs of admission consists of three arcs of admission.

8. The method of claim 3, further including reconfiguration of the plurality of second arcs of admission so as to enable full arc of admission through the plurality of second arcs of admission.

9. The method of claim 8, wherein the plurality of second arcs of admission consists of three arcs of admission.

10. A multi stage partial arc of admission steam turbine comprising:
an inner housing supporting a plurality of blade rows;
an outer housing surrounding an inner housing;
a first blade row at an upstream end of the plurality of blade rows;
a first arc of admission;
a first inlet line connected to the first art of admission;
at least one inlet belt in the inner housing downstream of the first blade row;
a duct, connecting the first inlet line and the at least one inlet belt fully contained within the outer housing; and wherein
the first inlet line is isolated from the first arc of admission between the duct and the first arc of admission.
